(19) United States
(12) Patent Application Publication
(10) Pub. No.: US 2005/0094503 A1
(43) Pub. Date: May 5, 2005

(54) Recording medium eject control apparatus and control method

(76) Inventor: Masato Higashi, Matsuyama-shi (JP)

Correspondence Address: Parkhurst & Wendel, 1421 Prince Street, Suite 210, Alexandria, VA, 22314-2805, US

(21) Appl. No.: 10/497,663

(22) PCT Filed: Nov. 28, 2002
(86) PCT No.: PCT/JP02/12466

(30) Foreign Application Priority Data
Dec. 4, 2001 (JP) 2001-369396

(51) Int. Cl. G11B 7/085

(52) U.S. Cl. 369/30.36

(57) ABSTRACT

In a removable disc drive apparatus having a plurality of switches for ejecting a disc, a user may operate erroneously. According to the present invention, a single eject switch (203) judges the state of the drive apparatus and specifies a normal mode or an emergency mode. Moreover, a power supply system is divided into two systems so that power is supplied from a connection point (P1) only to a portion required for eject utilizing an eject motor (209). Thus, it is possible to eject a disc only by using a small capacity of power.

### TECHNICAL FIELD

The present invention relates to a removable recording medium drive apparatus.

### BACKGROUND ART

A mechanism for ejecting a disc (a recording medium) is attached to a removable recording medium drive apparatus using a flexible disc, a tray loading optical disc or the like.

As examples of such an eject mechanism, there have been employed a method in which an eject mechanical switch is caused to act to operate a mechanism manually and eject a disc, and a method in which an electric eject switch is pushed to thereby cause a motor or a solenoid to be operated and automatically eject a disc.

In a case where a user himself or herself wants to eject a removable disc from a drive apparatus, the operation is implemented by pushing the eject switch, whereas if in the case, an operation such as reading a disc or writing to a disc is running, releasing-out of the disc interrupts the operation in running and the operation before the interruption becomes invalid. Especially, since while in writing, the interruption leads to data corruption, a case arises where there has been taken a measure that the eject switch is rendered ineffective during the operation.

On the other hand, in a case where a drive apparatus is not controllable for some reasons, or alternatively, in a case where a user wants to eject a disc urgently, a forced release mechanism has been provided if desired. In the forced release mechanism, a mechanism fixing a disc to a turn table is manually cancelled to thereby enable the disc to be ejected.

In JP-3067621-B, manual ejection in emergency is realized by providing a tray lock mechanism using a solenoid and a mechanism manually canceling a lock in a thin tray type optical disc drive apparatus.

In JP-2978931-B, a removable recording medium drive apparatus, using a tray, and into or from which a disc is loaded and unloaded in a slot-in loading scheme is disclosed in which a tray is provided on a lower shelf of a slot-in aperture through which an optical disc is inserted when the disc is loaded and the disc can be manually ejected, whereas in the apparatus, the tray has to be installed in addition to the slot-in loading mechanism, rendering the mechanism complex and in turn leading to cost-up.

In the case where the slot-in loading scheme is adopted in this way, since difficulty arises when the mechanism is manually canceled to thereby eject a disc, a forced release means is also obliged to use motor driving. In this case, there have been mounted two kinds including an eject switch for ordinary ejection and an emergency switch for forced release and even if any of the switches is pushed, a means for releasing the disc is the same, which is implemented with the help of motor driving. In the case of the eject switch, however, it is controlled by the drive apparatus whether or not ejection is permitted, while in the case of the emergency switch, the disc is ejected unconditionally.

FIGS. 7(a) and 7(b) show a conventional slot-in loading optical disc drive apparatus connected to a host computer 800.

Provided on a front panel 320 are, as shown in FIG. 7(a), an eject switch 303 and an emergency switch 307. A reference numeral 211 denotes a slot-in aperture.

A circuit configuration thereof is, as shown in FIG. 7(b), such that an optical disc drive apparatus is connected to the host computer 800 through a connector 118 and an ATAPI controller 114. The optical disc drive apparatus includes first and second detection circuits U1 and U2 for an eject switch 303 and an emergency switch 307, respectively, and a signal of the eject switch 303 is connected to an input port A1 of a microcomputer 302 through a resistance 304, a capacitor 305 and an inverter 306 for waveform shaping.

A signal of the emergency switch 307 is connected to an input port A2 of the microcomputer 302 through a resistance 308, a capacitor 309 and an inverter 310, which are equivalents to those of the eject switch 303, for waveform shaping.

The microcomputer 302 runs based on a control firmware stored in a ROM 301 to detect signals of the eject switch 303 and the emergency switch 307 separately as different signals and to conduct eject operations individually according to the respective signals. When an eject signal is generated from an output port C of the microcomputer 302, an eject motor 312 is driven through a power transistor circuit 311 to release the disc.

Note that while as shown in FIG. 7(a), the emergency switch 307 is harder to be pushed as compared with the eject switch 303, a user can push any of the switches at any timing. In this configuration, there is a possibility to push the emergency switch erroneously when the disc is not wanted to be released out, requiring two detection circuits U1 and U2 for the switches.

In a case where a slot-in loading recording medium drive apparatus has a recording medium eject function in emergency, the apparatus is rendered complex and in turn highly expensive if a mechanical eject method is applied. While one of the features of the slot-in loading scheme is to enable a thin structure to be realized, which makes it possible for the slot-in loading scheme to be mounted to a notebook personal computer, a problem arises in the example of JP-2978931-B that since a tray is provided on the lower shelf of the slot, it negates a thin type, therefore leading to a problem to disable the one feature to be practically realized.

Note that in order to realize the slot-in loading scheme without resulting in cost-up, a method is available in which an ordinary disc loading motor is used and an ordinary eject switch and an emergency switch are separately provided and selectively used, whereas a necessity arises for a user to selectively use two kinds of switches, and a possibility is considered to happen that a user is confused such that the emergency switch would be pushed in a case where ejection has to be avoided to thereby release a recording medium erroneously.

Especially, if in the midst of recording onto a recording medium, the emergency switch is pushed to thereby eject the recording medium, the recording medium left unfinished is not used any longer. Moreover, a necessity in the apparatus arises for two kinds of switches and two systems each including an accessory circuit and a harness, also resulting in a problem of cost-up, necessity for an extra space and the like.

In a state where a power supply is not turned on, a recording medium cannot be ejected. If a recording medium is taken out in a state where the recording medium is left in the interior out of operation, a necessity arises for a power supply to be turned on for the host computer and all the removable recording medium drive apparatus to thereby cause the whole system to be put into a drivable state; therefore, it takes a long time and useless power has to be consumed till the whole system is put into the drivable state.

### DISCLOSURE OF THE INVENTION

It is an object of the present invention to provide a recording medium eject control apparatus in which a user is not confused using two kinds of switches not to thereby render a recording medium useless due to unnecessary ejection.

In order to solve the problems, the present invention does not provide an eject switch and an emergency switch separately but provides a single eject switch, wherein the single eject switch is selectively used so that if a recording medium drive apparatus normally operates, it functions as an ordinary eject switch, while if the recording medium drive apparatus takes an anomalous state, it functions as the emergency switch.

If a mechanical eject scheme is not employed in order not to render the apparatus complex, a necessity arises for the apparatus to be handled only by an ordinary electric ejection also when abnormality or emergency occurs. By installing a plurality of power supply systems in order to realize such a necessity as much as possible, ejection can be effected without turning on a power supply for all the apparatus to thereby exert the minimum function necessary only for the ordinary eject operation with a specific power supply turned on.

A recording medium eject control apparatus according to claim 1 of the present invention is characterized by comprising: an eject switch for commanding ejection of a removable recording medium from a drive apparatus; recording medium eject means for automatically ejecting the removable recording medium from the drive apparatus; and control means for storing eject control patterns in a normal mode in which the drive apparatus normally operates and in an emergency mode in which the drive apparatus takes an anomalous state, determining whether a state of the drive apparatus when the eject switch is operated is in the normal mode or the emergency mode, and reading an eject control pattern according to a result of the determination to thereby drive the recording medium eject means and execute eject control.

A recording medium eject control apparatus according to claim 2 of the present invention is the apparatus according to claim 1, characterized by further comprising display means for presenting different displays in the respective cases in the normal mode and in the emergency mode.

A recording medium eject control apparatus according to claim 3 is the apparatus according to claim 1, characterized by further comprising: an auxiliary signal path for commanding eject execution to the recording medium eject means from the output of the eject switch without passing through the control means, separately from an ordinary signal path for commanding eject execution to the recording medium eject means by the control means; and change-over means for conducting eject control through the auxiliary signal path when the ordinary signal path is in a disable state.

A recording medium eject control apparatus according to claim 4 of the present invention is the apparatus according to claim 3 which is used in a removable recording medium drive apparatus connected to a host computer when being used, characterized by further comprising a separate power supply line isolated from the others as a power supply line for supplying power to the control means among the eject switch, the recording medium eject means, the auxiliary signal path and the control means, wherein ejection can be commanded to the recording medium eject means from the eject switch through the auxiliary signal path in a state where power supply to the control means is turned off, while power supply to the eject switch, the recording medium eject means and the auxiliary signal path is turned on.

A recording medium eject control apparatus according to claim 5 of the present invention is the apparatus according to claim 1, wherein the control means is constructed so as to detect by discrimination a case where the eject switch has been continued to be operated for a determined period or more, or a case where the eject switch has been operated within the determined period and vice versa, and thereby executes different eject controls according to respective both cases.

A removable recording medium drive apparatus according to claim 6 of the present invention is mounted with the recording medium eject control apparatus according to any of claims 1 to 5.

A recording medium eject control method according to claim 7 of the present invention is a method for eject execution of a removable recording medium from a drive apparatus, characterized by comprising the steps of: determining a state of the drive apparatus when an eject switch is operated; and reading an eject control pattern according to a result of the determination to run recording medium eject means and to execute different eject controls according to respective cases in a normal mode in which the drive apparatus runs normally and in an emergency mode in which the drive apparatus takes an anomalous state.

A recording medium eject control method according to claim 8 of the present invention the method according to claim 7, characterized by further comprising the step of driving display means so as to present different displays according to the respective cases in the normal mode and in the emergency mode.

A recording medium eject control method according to claim 9 of the present invention the method according to claim 7, characterized by further comprising the step of: detecting that an ordinary signal path for commanding eject execution to recording medium eject means from control means for executing reading of an eject control pattern according to a result of determination on a state of the drive apparatus made therein when an eject switch is operated is in a disable state; and commanding the eject execution to the recording medium eject means through an auxiliary signal path different from the ordinary signal path from the output of the eject switch without passing through the control means.

A recording medium eject control apparatus according to claim 10 of the present invention executes the recording medium eject control method according to any one of claims 7 to 9.

### BRIEF DESCRIPTION OF THE DRAWINGS

FIG. 1 is a front view and a block diagram of a removable recording medium drive apparatus which employs a recording medium eject control apparatus according to Embodiment 2 of the present invention.

FIG. 2 is a flowchart of a main part of an eject processing of Embodiment 2.

FIG. 3 is a timing diagram describing the eject processing of Embodiment 2.

FIGS. 4(a) and 4(b) are a front view and a block diagram of a removable recording medium drive apparatus which employs a recording medium eject control apparatus according to Embodiment 1 of the present invention.

FIGS. 5(a) to 5(d) are flowcharts of an eject processing of Embodiment 1.

FIG. 6 is a flowchart of a main part of an eject processing of Embodiment 3 of the present invention.

FIGS. 7(a) and 7(b) are a front view of a conventional removable recording medium drive apparatus and a block diagram of a conventional recording medium eject control apparatus.

### BEST MODE FOR CARRYING OUT THE INVENTION

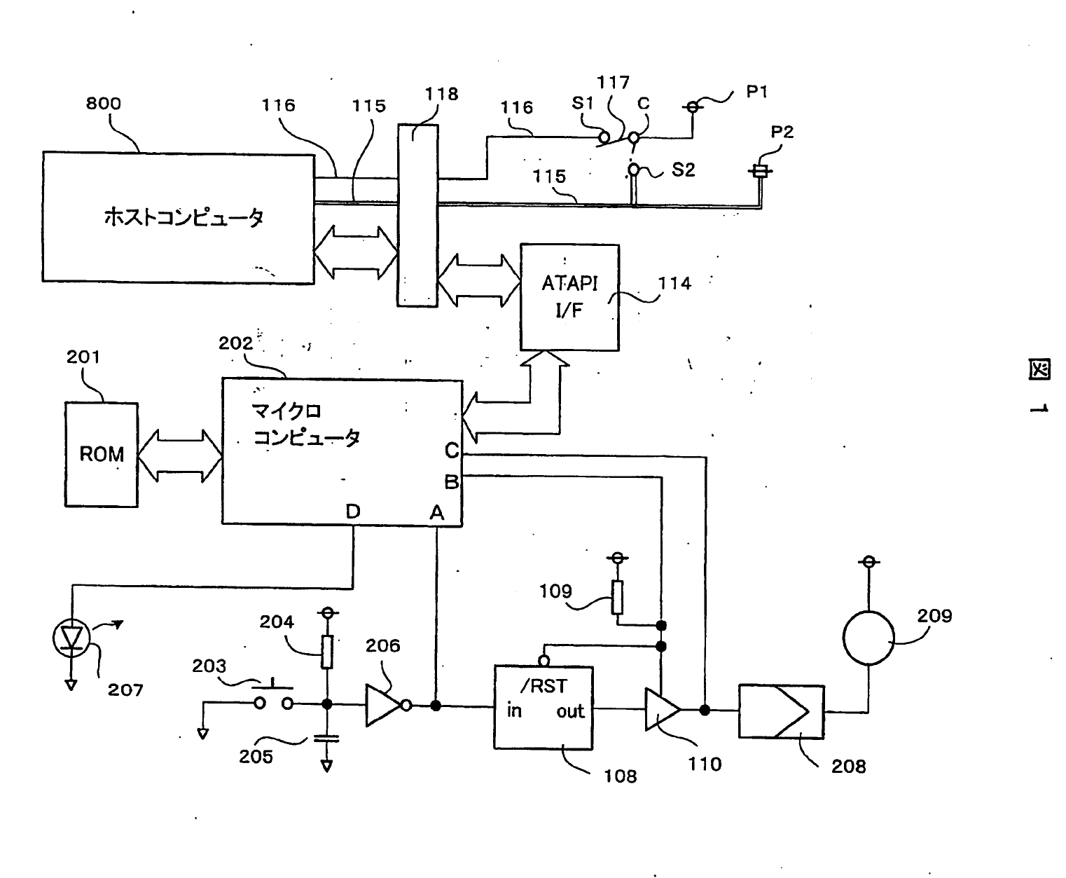

Description will be given of embodiments of the present invention below based on FIGS. 1 to 6.

(Embodiment 1)

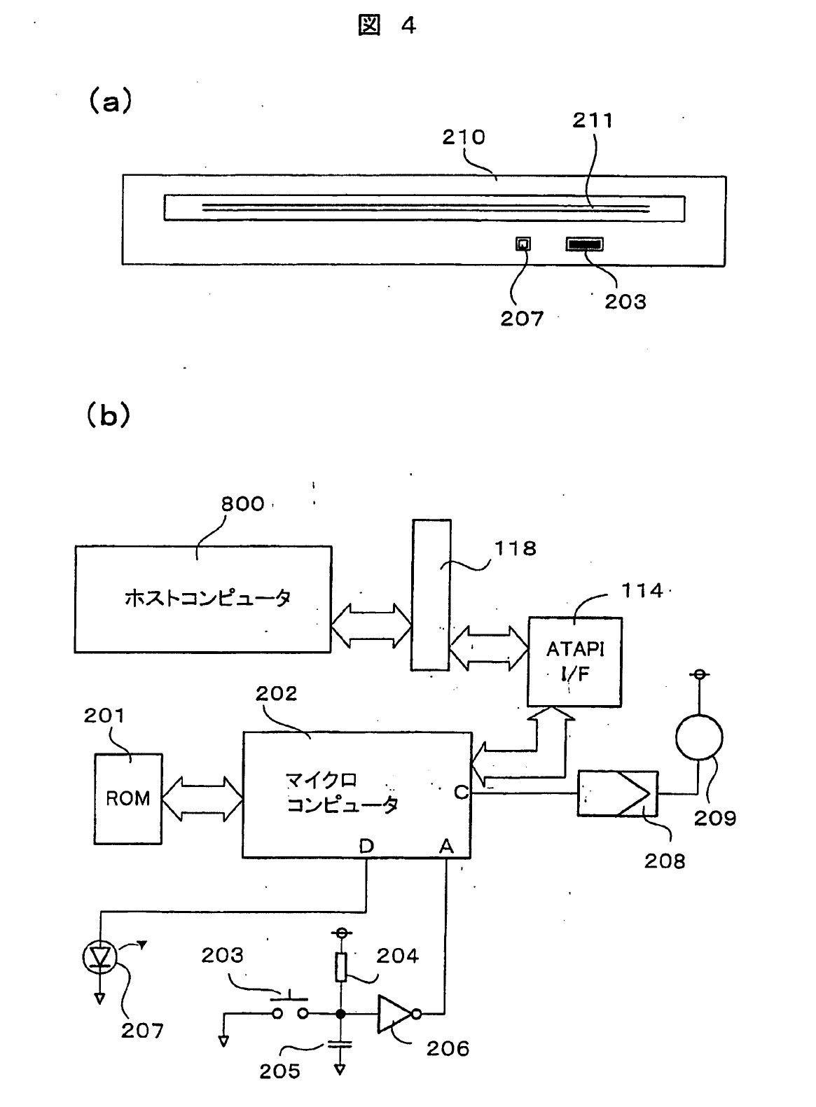

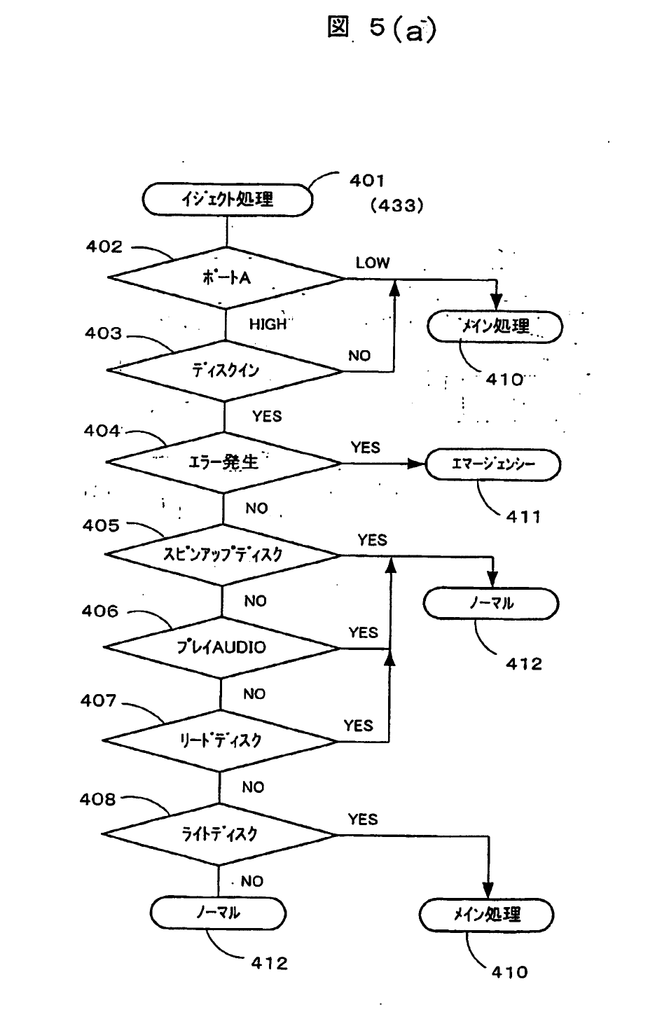

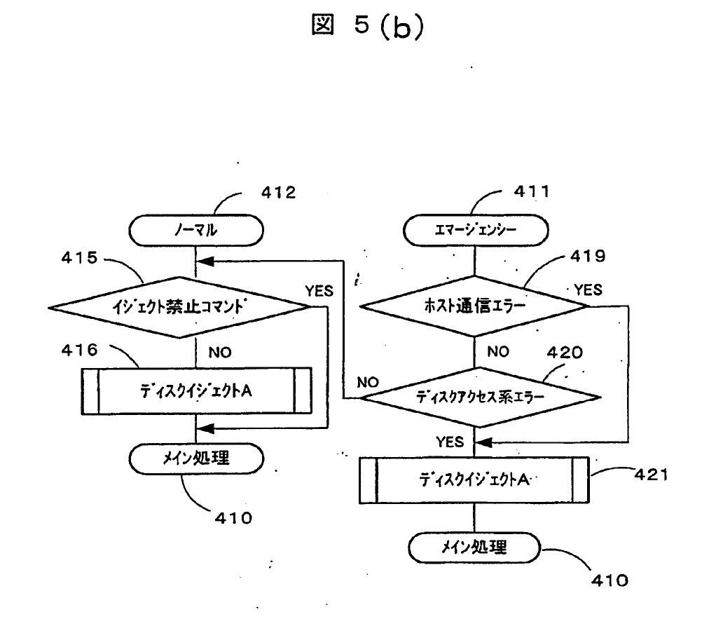

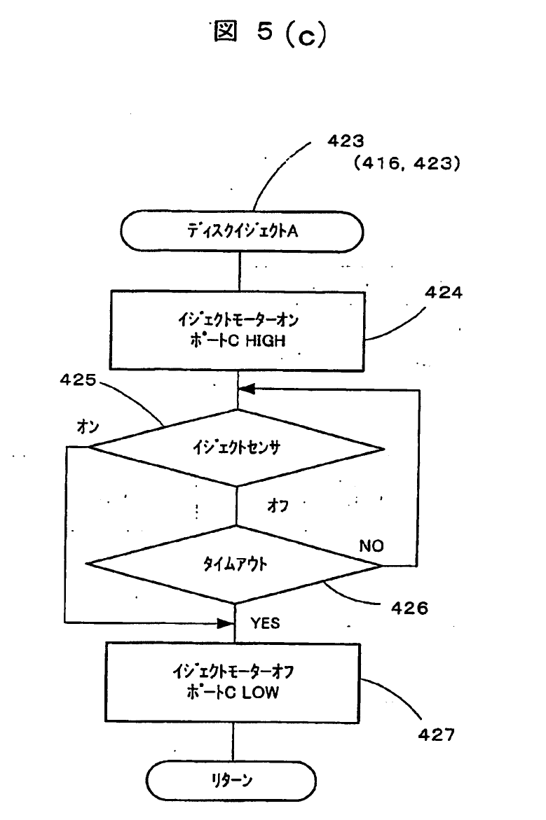

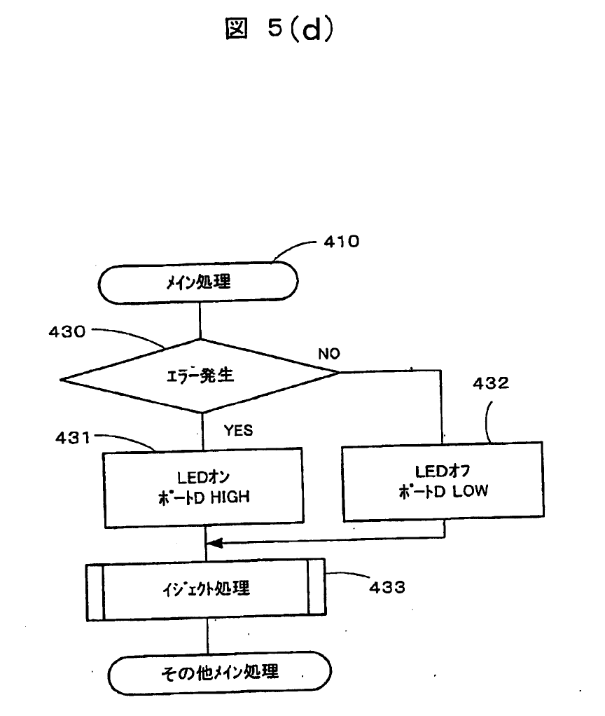

FIGS. 4(a) and 4(b) and FIGS. 5(a) to 5(d) show a recording medium eject control apparatus of Embodiment 1 of the present invention. A removable recording medium drive apparatus equipped with the recording medium eject control apparatus is connected when being used to a personal computer and description will be given thereof with the personal computer as a host computer 800 for the removable recording medium drive apparatus.

In a front panel 210, as shown in FIG. 4(a), disposed are an eject switch 203 and a light emitting diode 207 as a display means. A reference numeral 211 indicates a slot-in aperture.

The removable recording medium drive apparatus has, as shown in FIG. 4(b), a circuit configuration to be connected to the host computer 800 through a connector 118 and an ATAPI controller 114. A signal of the eject switch 203 is connected to an input port A of a microcomputer 202 as a control means through a resistance 204, a capacitor 205 and a schmitt trigger inverter 206 for waveform shaping.

The microcomputer 202 conducting an overall sequence control for the removable recording medium drive apparatus runs based on a control firmware stored in a ROM 201 to detect a signal of the eject switch 203 and conduct an eject processing for a recording medium. When an eject signal is outputted from an output port C of the microcomputer 202, an eject motor 209 as a recording medium eject means for automatically ejecting the recording medium is driven through a power transistor circuit 208 to release out the recording medium.

To be concrete, the input port A of the microcomputer 202 is at “LOW” level since the input of the schmitt trigger inverter 206 is pulled up by the resistance 204 when the eject switch 203 is open. When the eject switch 203 is pushed to be turned on, waveform shaping is effected and a “HIGH” pulse is inputted to the input port A. When the “HIGH” pulse is received at the input port A, a recording medium eject signal is outputted from the output port C of the microcomputer 202.

The eject motor 209, which is used to eject a recording medium, is rotated in a normal direction or a reverse direction and thereby used in ejection and loading both.

The light emitting diode 207 is connected to an output port D of the microcomputer 202 and lit up by a “HIGH” output of the output port D.

FIGS. 5(a) to 5(d) show a construction of a control means including the microcomputer 202 and the ROM 201.

Description will be selectively given of cases in the normal mode in a normal state and the emergency mode in an abnormal state, when the eject switch 203 is pushed.

An eject processing flow 401 shown in FIG. 5(a) is a start portion of the eject processing, which is called from a main processing (FIG. 5(d)) conducting an overall control of the removable recording medium drive apparatus.

In Step 402, it is determined whether or not the eject switch 203 has been pushed. If the port A is at “HIGH” level, the switch has been pushed. In a case of “LOW”, the process returns to the main processing 410.

In Step 403, it is checked whether or not a recording medium has been inserted and if not inserted, the process returns to the main processing 410. If the recording medium has been inserted, an error occurrence state is checked in Step 404, and if an error has occurred, the process moves to the processing 411 in the emergency mode. If no error has occurred, operating modes of normal operations in Steps 405 to 408 are checked.

To be concrete, a spin-up disc is checked in Step 405, a play audio in Step 406 and a read disc in Step 407, and if any of them is in operation, the process moves to a processing 412 in the normal mode. In determination on a write disc in Step 408, if the disc is in writing, no ejection is effected and the process returns to the main processing 410. While there have been available a removable recording medium drive apparatus for CD-R, CD-RW as a recordable recording medium, there is a risk that if these recording media are stopped partway in writing, all data in a medium cannot be reproduced; therefore, ejection is prohibited when the medium is normally in writing. If ejection is necessary, a command of write stop is issued from the host computer to the removable recording medium drive apparatus to alter a state thereof, and thereafter, eject processing can be effected. When a disc is not in writing, but in another state, the process advances to the normal mode 412 shown in FIG. 5(b).

The processing 412 in the normal mode is constructed in the following way.

In Step 415, determination on an eject prohibit command is conducted. Eject prohibition can be effected using a standard command PREVENT/ALLOW MEDIUM REMOVAL of ATAPI or SCSI from the host computer 800. In a case where no ejection is prohibited, a processing 423 of “disc eject A” shown in FIG. 5(c) is called in Step 416 and the disc is ejected and thereafter, the process returns to the main processing 410.

A processing 411 in the emergency mode executes Step 419. In Step 419, an error is checked in communication with the host computer 800. Since, in this step, determination on the eject prohibit command is not correctly effected, the process moves to Step 421 to call a processing 423 of “disc eject A” shown in FIG. 5(c) and to immediately execute ejection and thereafter, the process returns to the main processing 410.

It is checked in Step 420 whether or not an error occurs in disc access. Main examples of errors in disc access include spin-up, play audio, read disc and write disc. In a case where these errors occur, there is a high necessity for exchanging discs; therefore, the process moves to Step 421 to call a processing 416 of “disc eject A” shown in FIG. 5(c) and to immediately execute ejection and thereafter, the process returns to the main processing 410. In a case except for an error in communication with the host computer and errors in disc access, the process returns to Step 415 based on the processing in the normal mode.

A routine of “disc eject A” shown in FIG. 5(c) is constructed in the following way.

In Step 424, the output port C is rendered “HIGH” in order to drive the eject motor 209. Thereby, the eject motor 209 is driven through the power transistor circuit 208. Although not shown, when a disc moves to a position where being ejected, an eject sensor with a micro switch is provided and thereby turned on.

In Step 425, determination on output of the eject sensor is executed. If the eject sensor has been turned on, the port C is caused to take “LOW” level output in Step 427 to stop the eject motor 209. Step 426 is inserted in a case where the inject sensor is not turned on due to malfunction of the eject sensor, and when a determined time elapses as a result of checking a time-out in Step 426, the eject motor 209 is stopped. If the eject sensor malfunctions, the disc can be expected to be ejected by driving the eject motor 209 for a determined time. After the eject motor 209 is stopped, the process returns to the previous step of FIG. 5(b) where “disc eject A” was called to execute the main processing 410.

FIG. 5(d) shows the main processing 410.

During the main processing 410 controlling all the removable recording medium drive apparatus, it is determined in step 430 whether or not the removable recording medium drive apparatus is in an error occurrence state. If the removable recording medium drive apparatus is in an erroneous state, the port D assumes “HIGH” output in Step 431 to turn on the light emitting diode 207. If not in the erroneous state, the port D assumes “LOW” in Step 432 to turn off the light emitting diode 207. Thereafter, the eject processing flow 401 shown in FIG. 5(a) is executed in Step 433.

Since automatic change-over is effected between the normal mode and emergency mode in operation according to a state on the side of the removable recording medium drive apparatus with such a construction adopted, an eject operation can be ensured without leading to confusion on the side of a user.

Moreover, since the operation can be ceased on the side of the removable recording medium drive apparatus when a situation is not to be ejected, no disc part way in recording is wasted.

(Embodiment 2)

FIGS. 1 to 3 show Embodiment 2 of the present invention.

While in Embodiment 1, the output of the inverter 206 is connected only to the port A of the microcomputer 202, in Embodiment 2, the output of the inverter 206 is connected to the input of the power transistor circuit 208 through a pulse generating circuit 108 and a tristate gate circuit 110.

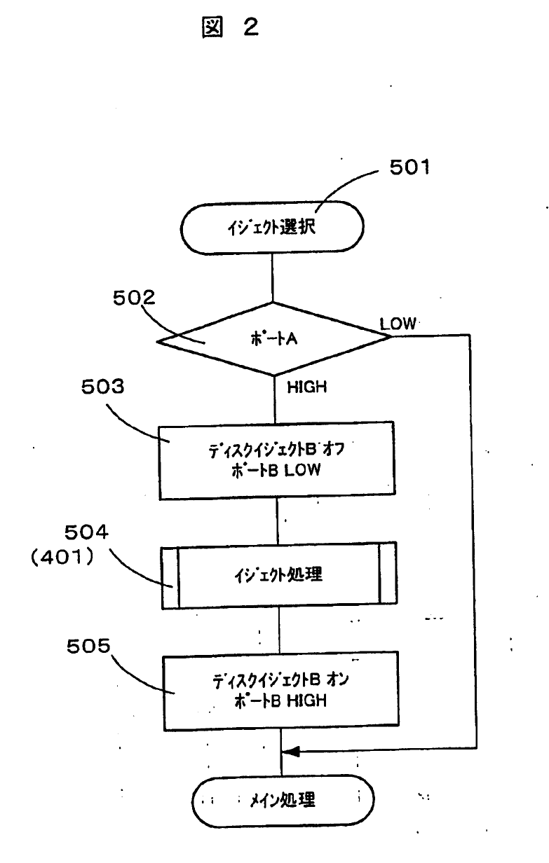

Part of the ROM 201 is altered so as to execute FIG. 2 instead of the eject processing 401 in Step 433 of FIG. 5(d).

The pulse generating circuit 108, when a falling input from “HIGH” to “LOW” is given to the in terminal, supplies a “HIGH” output with a determined period from the out terminal. /RST is a reset terminal of the pulse generating circuit 108 and the circuit is reset to assume “LOW” output by “LOW” input to the reset terminal.

The tristate control terminal of the tristate gate circuit 110 is not only pulled up by the resistance 109, but also connected to the output port B of the microcomputer 202.

The out terminal of the pulse generating circuit 108 is inputted to a power transistor circuit 111 through the tristate gate circuit 110 and the power transistor 208 drives the eject motor 209. The output of the tristate gate circuit 110 and the output of the port C of the microcomputer 202 are inputted to the power transistor circuit 208 in wired OR connection. When the output port B takes “HIGH”, the tristate gate circuit 110 can output, while when the output port B takes “LOW”, the output of the tristate gate circuit 110 is in an open state to render only connection between the power transistor circuit 208 and the port C effective.

An eject processing using the pulse generating circuit 108 and the tristate gate circuit 110 is hereinafter referred to as “disc eject B” and an eject processing controlled by the microcomputer 202 described in FIG. 5 is hereinafter referred to as “disc eject A”.

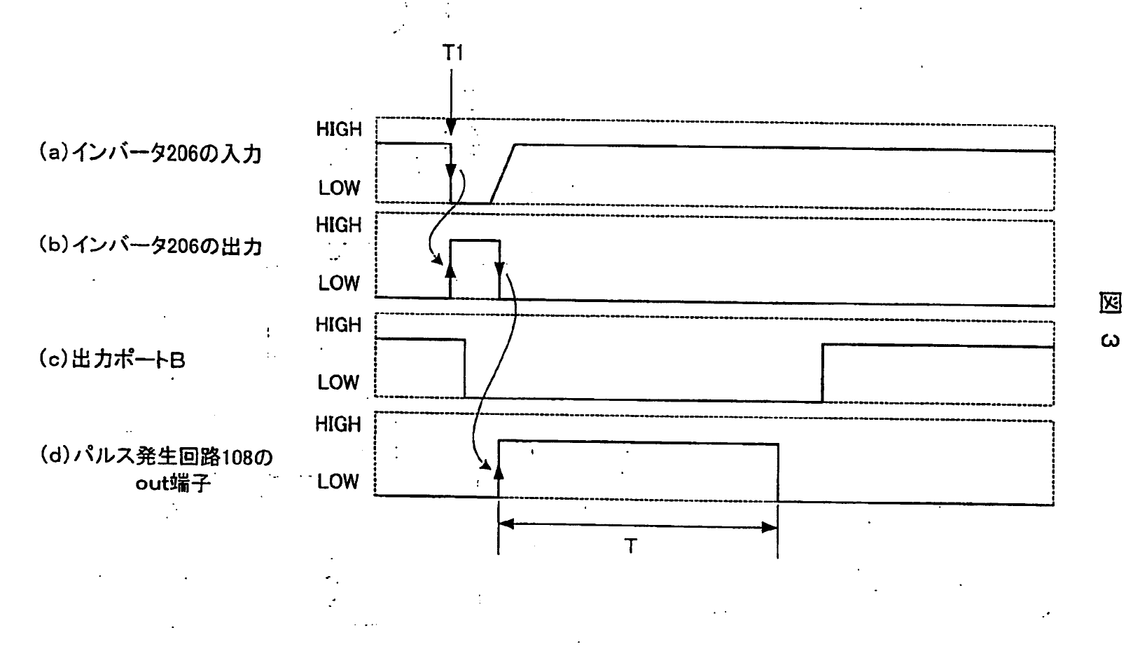

FIG. 2 is a flowchart to control two kinds of eject means and FIG. 3 shows timings of constituents related to ejection. The flow 501 conducts eject selection called from the main processing. In Step 502, a port A input is checked to detect a rise from “LOW” to “HIGH” when the eject switch 203 is pushed. Detection of a rise can be realized by using an interrupt function of the microcomputer 202.

The microcomputer 202 changes over the port B to a “LOW” output when the port A input is rendered “HIGH” to thereby invalidate “disc eject B”.

An eject processing executed in Step 504 is the processing described in Step 433 of FIG. 5(d) and the “disc eject A” is executed. After the eject processing, the output port B is rendered back “HIGH” to cause “disc eject B” to be in an enable state.

Note that since the port B is at “HIGH” level on power-on of the removable recording medium drive apparatus, at an initial state after reset of the apparatus and in a state where the microcomputer 202 is not activated, “disc eject B” on the occasions is in an enable state. While the microcomputer 202 normally operates by control of the flow 501 for eject selection, “disc eject A” is effective. On the other hand, in a state where the microcomputer 202 does not normally operates or is in an inactive state, the port B does not assume “LOW” level. Therefore, “disc eject B” is rendered effective.

Description will be given using the chart of FIG. 3.

The symbol (a) indicates a signal of an eject switch and an input signal of the inverter 206.

The symbol (b) indicates an output signal of the inverter 206.

The symbol (c) indicates the output port B.

The symbol (d) indicates a waveform at the output terminal of the pulse generating circuit 108.

The eject switch 203 is pushed at a timing T1, the output signal of the inverter 206 is inverted as shown in (b) of FIG. 3. The microcomputer 202 detects that the eject switch 203 is operated at the rising edge of the port A to render the port B to “LOW” output as shown in (c) of FIG. 3. When the port B is “LOW”, no pulse is generated at the out terminal of the pulse generating circuit 108. If the port B is not rendered to “LOW” because of abnormality in the microcomputer 202, the pulse generating circuit 108 generates a pulse with a cycle T as shown in (d) of FIG. 3 with the falling edge of an output signal of the inverter 206 shown in (b) of FIG. 3 as a trigger.

The cycle T is a predetermined value and it is set so that a disc can be ejected by driving the inject motor 209 only in the period.

With such a circuit configuration adopted, ejection can be executed by changing over from “disc eject A” to “disc eject B” when “disc eject A” is in a disable state.

The removable recording medium drive apparatus and the host computer 800 are connected to each other by the connector 118. An ATAPI interface signal and a power supply line from the host computer to the removable recording medium drive apparatus enter the connector 118. The ATAPI signal is connected to an ATAPI controller 114.

The power supply line through which power is supplied from the host computer 800 to the removable recording medium drive apparatus is constructed with two systems including a first power supply line 115 and a second power supply line 116, respectively.

The power supply from the second power supply line 116 is changed over to the side of a contact point S1 at a contact point C of a switch 117 to supply power, as a power supply, from a connection point P1 to one end of the resistance 204, to one end of the resistance 109, to one end of the eject motor 209, to the inverter 206, to the pulse generating circuit 108, to the tristate gate circuit 100 and to others. The switch 117 can be changed over manually.

The contact point C of the switch 117 is connected to the side of the contact point S2 by change-over of the switch 117, whereby the power supply of the first power supply line 115 supplies power to the one end of the resistance 204, to the one end of the resistance 109, to the one end of the eject motor 209, to the inverter 206, to the pulse generating circuit 108, to the tristate gate circuit 100 and to others.

The switch 117 is usually set in a state where the contact point C thereof is connected to the side of the contact point S2 by change-over of the switch 117. Constituents not connected to the connection point P1 of the removable recording medium drive apparatus are supplied with power from the first power supply line 115 through the connection point P2.

Note that the power transistor circuit 208 can be constructed only with open collector transistors or constituted of a transistor circuit operated by power supply from the connection point P1 to drive the eject motor 209.

With such a construction adopted, in a case where the main power supply of the host computer 800 is turned off to thereby cease power supply to main constituents of the removable recording medium drive apparatus, a user changes over the switch 117 to the side of the contact point S1 to thereby enable power to be supplied only to constituents necessary for execution of “disc eject B” through the connection point P1 from the second power supply line 116, thereby enabling the ejection.

Note that while in this embodiment, the switch 117 works as a manually operable switch, a configuration can be adopted in which the switch 117 works being interlocked with the power supply switch of the host computer 800 so that when the power switch of the host computer 800 is turned off, the switch 117 is changed over to the side of the contact point S1, while when the power switch of the host computer 800 is turned on, the switch 117 is changed over to the side of the contact point S2, thereby enabling only power supply from the connection point P2 to be left alive and improve operability despite turning off of the main power supply of the host computer 800.

(Embodiment 3)

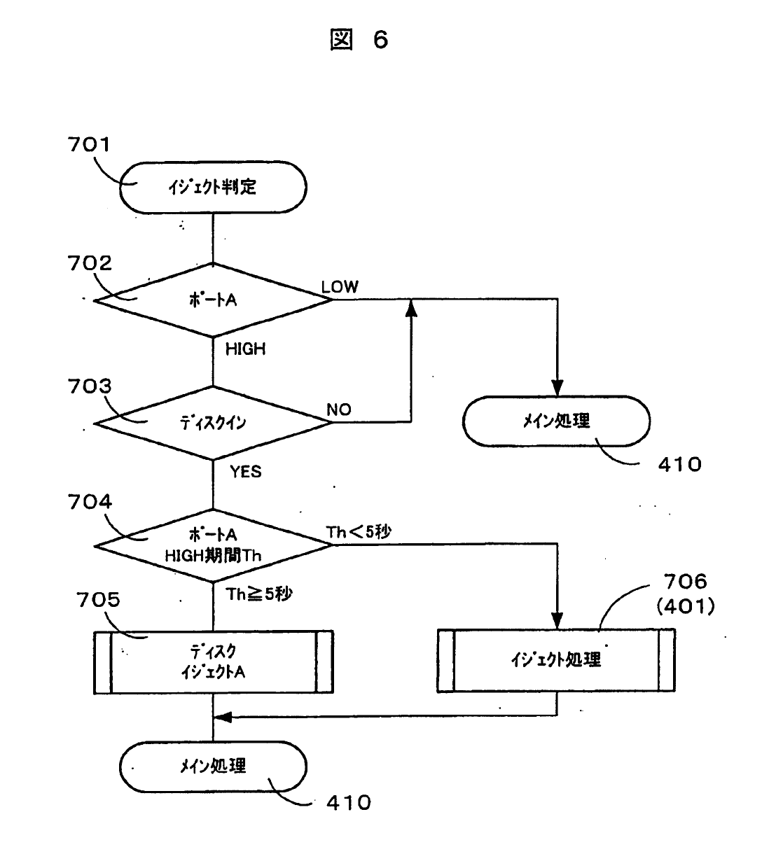

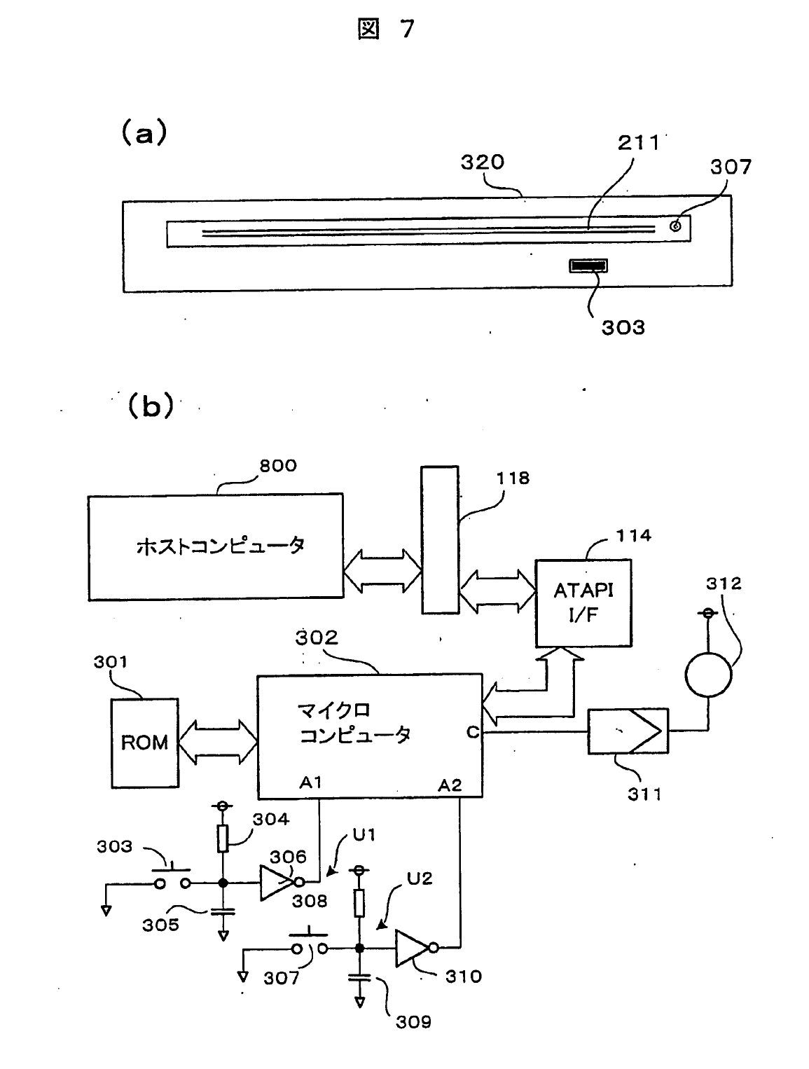

FIG. 6 shows Embodiment 3 of the present invention.

A flow of determination on ejection 701 shown in FIG. 6 is executed instead of eject processing in Step 433 of FIG. 5(d) in Embodiment 1. The other flows of the chart are the same as those in Embodiment 1.

The determination on ejection 701 is called from the main processing 410.

In Step 702, an input to the port A is checked, and when the input is “HIGH”, it is checked in Step 703 whether or not a recording medium has been inserted and if the recording medium is present, checked is a period Th during which an input signal to the port A is continuously kept to be “HIGH”. If the period Th is equal to or more than five seconds, “disc eject A” in the flow 423 of FIG. 5(c) is immediately executed in Step 705 to eject the disc.

If the period Th is less than five seconds, the eject processing 401 of FIG. 5(a) is executed in Step 706 as an ordinary eject processing.

A time length of five seconds of the period Th when the input signal to the port A is “HIGH” is rendered programmable, for example, to thereby enable the time length to be altered according to a command from the host computer 800 as well. Thereby, a user can eject a disc unconditionally when required and erroneous ejection can be prevented with the sufficiently long period Th adopted.

Note that while in the above embodiments, a slot-in loading optical disc drive apparatus is used, a tray loading disc drive apparatus or the like, which is different from the former apparatus, adopts the above-described eject means instead of a mechanical eject means and thereby can enjoy an advantageous point such as to simplify an overall construction.

According to a recording medium eject control apparatus of the present invention, as described above, since the control means determines a state of the drive apparatus when the eject switch is operated, operations in the normal mode and the emergency mode can be selectively changed over therebetween with a single eject switch on the disc drive apparatus side according to a state thereof, a user has no chance to be confused by two kinds of switches and ejection prohibited while no ejection is allowed, for example during a recording operation, and thereby no recording medium is wasted due to unnecessary ejection.

Since provided is the display means presenting differently depending on a case in the normal mode or a case in the emergency mode, a user can recognize a state of the drive apparatus.

When the ordinary signal path falls into a disable state, an output of the eject switch is transmitted to the recording medium eject means through the auxiliary signal path to command execution of ejection; therefore, even if normal ejection by the control means including the microcomputer and others is non-operable, ejection can be conducted through the auxiliary signal path, that is with a fail-safe construction adopted, reliability of ejection is improved.

Since a power supply line supplying power to the control means, among the eject switch, the recording medium eject means, the auxiliary signal path and the control means, is provided as a separate power supply line from the other lines, power is supplied only to constituents related to ejection with a small capacity of a power supply while turning off the main power supply, thereby enabling the ejection to be realized.

If the control means is constructed so as to detect by discriminating a case where the eject switch is continuously kept operated for a determined period or longer from a period less than the determined period when the eject switch is operated and different eject controls are implemented in the respective cases, a user can realize a forced ejection of a disc if desired by continuously pushing the eject switch. With a single eject switch adopted, due eject processing can be selectively executed between cases in the normal mode and the emergency mode by altering a time during which the eject switch is kept pushed.

1. A recording medium eject control apparatus, comprising:
an eject switch for commanding ejection of a removable recording medium from a drive apparatus;
recording medium eject means for automatically ejecting the removable recording medium from the drive apparatus; and
control means for storing eject control patterns in a normal mode in which the drive apparatus normally operates and in an emergency mode in which the drive apparatus takes an anomalous state, determining whether a state of the drive apparatus when the eject switch is operated is in the normal mode or the emergency mode, and reading an eject control pattern according to a result of the determination to thereby drive the recording medium eject means and execute eject control.

2. The recording medium eject control apparatus according to claim 1, further comprising display means for presenting different displays in the respective cases in the normal mode and in the emergency mode.

3. The recording medium eject control apparatus according to claim 1, further comprising: an auxiliary signal path for commanding eject execution to the recording medium eject means from the output of the eject switch without passing through the control means, separately from an ordinary signal path for commanding eject execution to the recording medium eject means by the control means; and change-over means for conducting eject control through the auxiliary signal path when the ordinary signal path is in a disable state.

4. The recording medium eject control apparatus according to claim 3, which is used in a removable recording medium drive apparatus connected to a host computer when being used, comprising:
a separate power supply line isolated from the others as a power supply line for supplying power to the control means among the eject switch, the recording medium eject means, the auxiliary signal path and the control means, wherein
ejection can be commanded to the recording medium eject means from the eject switch through the auxiliary signal path in a state where power supply to the control means is turned off, while power supply to the eject switch, the recording medium eject means and the auxiliary signal path is turned on.

5. The recording medium eject control apparatus according to claim 1, wherein the control means is constructed so as to detect by discrimination a case where the eject switch has been continued to be operated for a determined period or more, or a case where the eject switch has been operated within the determined period and vice versa, and thereby executes different eject controls according to respective both cases.

6. A removable recording medium drive apparatus mounted with the recording medium eject control apparatus according to any claim 1.

7. A recording medium eject control method for eject execution of a removable recording medium from a drive apparatus, comprising the steps of:
determining a state of the drive apparatus when an eject switch is operated; and
reading an eject control pattern according to a result of the determination to run recording medium eject means and to execute different eject controls according to respective cases in a normal mode in which the drive apparatus runs normally and in an emergency mode in which the drive apparatus takes an anomalous state.

8. The recording medium eject control method according to claim 7, further comprising the step of driving display means so as to present different displays according to the respective cases in the normal mode and in the emergency mode.

9. The recording medium eject control method according to claim 7, further comprising the step of:
detecting that an ordinary signal path for commanding eject execution to recording medium eject means from control means for executing reading of an eject control pattern according to a result of determination on a state of the drive apparatus made therein when an eject switch is operated is in a disable state; and
commanding the eject execution to the recording medium eject means through an auxiliary signal path different from the ordinary signal path from the output of the eject switch without passing through the control means.

10. A recording medium eject control apparatus which executes the recording medium eject control method according to claim 7.
